(19) United States
(12) Patent Application Publication
(10) Pub. No.: US 2023/0351527 A1
(43) Pub. Date: Nov. 2, 2023

(54) INTEGRATED DEVELOPMENT OPTIMIZATION PLATFORM FOR WELL SEQUENCING AND UNCONVENTIONAL RESERVOIR MANAGEMENT

(71) Applicant: ConocoPhillips Company, Houston, TX (US)

(72) Inventors: Jing Peng, Houston, TX (US); Jamie McEwen, Houston, TX (US); Vishal Bang, Calgary (CA); Lauren A. Borden, Houston, TX (US); Matthew E. Nelson, Houston, TX (US); Edythan M. Rayfield, Houston, TX (US)

(21) Appl. No.: 18/139,534

(22) Filed: Apr. 26, 2023

Related U.S. Application Data
(60) Provisional application No. 63/363,782, filed on Apr. 28, 2022.
(60) Provisional application No. 63/408,904, filed on Sep. 22, 2022.

(51) Int. Cl. G06Q 50/02; G06Q 10/0631; G06Q 10/0637

(52) U.S. Cl. CPC G06Q 50/02; G06Q 10/06315; G06Q 10/0637

(57) ABSTRACT

Implementations described and claimed herein provide systems and methods for an integrated development optimization platform for well sequencing and unconventional reservoir management. The platform integrates key elements of unconventional development planning, such as production forecast, lease obligations, surface facilities, and economics and provides analysis and data associated with past and future field development and production. In addition, development optimization platform includes the parent-child relationship as one of the determining factors of production performance, which can provide valuable insights into the frac-hit impact and infill performance. The defensive re-fracs may also be incorporated to provide a more holistic view on project investment and field development. The development optimization platform is not only an optimization platform for well sequence and development planning, but also a reservoir management tool.

### CROSS-REFERENCE TO RELATED APPLICATION

This application is related to and claims priority under 35 U.S.C. § 119(e) from U.S. Patent Application No. 63/363,782 filed Apr. 28, 2022 entitled “An Integrated Development Optimization Platform for Well Sequencing and Unconventional Reservoir Management,” and U.S. Patent Application No. 63/408,904 filed Sep. 22, 2022 entitled “An Integrated Development Optimization Platform for Well Sequencing and Unconventional Reservoir Management,” the entire contents of both of which are incorporated herein by reference for all purposes.

### FIELD

Aspects of the present disclosure relate generally to systems and methods for developing well sequencing and unconventional reservoir management and, more particularly, to an optimization platform for dynamically integrating subsurface data and development considerations to automatically generate a well sequence for production optimization.

### BACKGROUND

Modern reservoir management processes generally include setting strategy, development planning, implementing, monitoring, and evaluating results. Development planning, in particular, may include addressing subsurface and surface uncertainties, generating forecasts on production performance and economic values, and optimizing facilities design. There have been many established practices and tools for conventional field planning, such as mature data acquisition program and analytical/simulation models based on abundant data. However, the process is more challenging for unconventional reservoirs due to their special characteristics of short development history, extremely low permeability, relatively tight well spacing, fast development pace, large number of wells, etc.

Selecting wells for a rig schedule may be a complicated optimization problem with multiple considerations, such as lease obligations, central facility capacities, production optimization, and simultaneous operations. Therefore, well sequencing is not a standalone process, but rather should be integrated with the reservoir management process to achieve the goals to optimize production performance, asset value, capital, and operational expenses. Further, many sites may include hundreds or even thousands of inventory wells in unconventional development, making well sequencing in such areas nearly impossible to do manually. Integrated and automated field development planning can greatly improve the efficiency of well sequencing and reservoir management of unconventional reservoirs. Many field development plans (FDP) have been proposed for rig scheduling optimization for conventional development planning, with very few that provide an integrated view for unconventional reservoirs.

One of the big differences between unconventional and conventional reservoirs is the parent-child relationship. Because of the relatively tight well spacing and large proppant loading during stimulation, the interaction between parent and child wells in unconventional reservoirs is much stronger and often poses production risks to both parent (frac-hit) and child (infill degradation) wells. Many studies have shown the timing of infill drilling has tremendous impact on the parent-child interaction such that integration of the well sequencing optimization into development planning is important.

It is with these observations in mind, among others, that various aspects of the present disclosure were conceived and developed.

### SUMMARY

Implementations described and claimed herein address the foregoing problems by providing systems and methods for optimizing production and economic value of a well, pad, hydrocarbon reservoir, oilfield, and/or field. The production optimization may include the operations of receiving, using a processing device and from a plurality of databases, data corresponding to one or more wells of the field, generating, based on the received data, a production and value forecast for the one or more wells of the field, verifying potential defensive refract candidates of the one or more wells of the field, and generating, based on production and value forecast and verified potential defensive refract candidates, a well development sequence for the field.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however the emphasis instead is being placed on illustrating the principles of the inventive concepts. Also, in the drawings the like reference characters may refer to the same parts or similar throughout the different views. It is intended that the embodiments and figures disclosed herein are to be considered illustrative rather than limiting.

FIG. 1 shows an example network environment that may implement various systems and methods discussed herein.

FIG. 2 is a block diagram illustrating an example inputs and outputs of a development optimization platform.

FIG. 3 shows an example block diagram of a development optimization platform for well sequencing and unconventional well management.

FIG. 4 shows an overhead representation of a field with drilled and undrilled well events.

FIG. 5 illustrates example operations for utilizing a development optimization platform for well sequencing and unconventional well management.

FIG. 6A is an example user interface illustrating a bar chart and pie chart of rig allocation over time in different type curve areas of a field based on data from a development optimization platform.

FIG. 6B is an example user interface illustrating a bar chart of change of average infill degradation over time of a field based on data from a development optimization platform.

FIG. 7 is an example user interface illustrating line graphs of change of the effect of a central facility constraint on aspects of output data of a field.

FIG. 8 is an example user interface illustrating line graphs of different well outputs based on different well facility capacities.

FIG. 9 shows an example computing system that may implement various systems and methods discussed herein.

### DETAILED DESCRIPTION

Aspects of the present disclosure involve systems and methods for an integrated development optimization platform for well sequencing and unconventional reservoir management. The platform integrates key elements of unconventional development planning, such as production forecast, lease obligations, surface facilities, and economics and provides analysis and data associated with past and future field development and production. In addition, development optimization platform includes the parent-child relationship as one of the determining factors of production performance, which can provide valuable insights into the frac-hit impact and infill performance. The defensive re-fracs may also be incorporated to provide a more holistic view on project investment and field development. The development optimization platform is not only an optimization platform for well sequence and development planning, but also a reservoir management tool. The platform dynamically integrates development considerations with subsurface learnings and automatically generates an optimized well sequence and related production and economics. The special characteristics of unconventional development, such as parent-child relation and frac-hit impact, are included for more reliable results. Defensive refracs and their association with infills may also be incorporated for a more holistic view on project investment and field development. With the uncertainties in price environment and capital availability of a field, the development optimization platform provides a powerful reservoir management platform to look at multiple scenarios and the impact of near-term decisions to future unconventional development.

These and other advantages may become apparent from the discussion included herein.

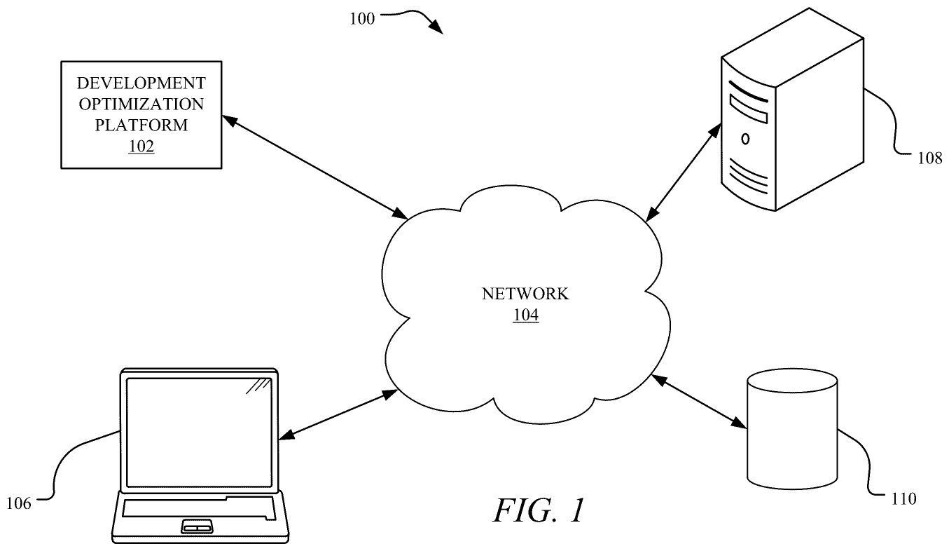

To begin a detailed discussion of an example well sequencing and reservoir management system 100, reference is made to FIG. 1. In particular, FIG. 1 depicts a network 104 is used by one or more computing or data storage devices for implementing the systems and methods for a development optimization platform (DOP) 102 for well sequencing and reservoir management. In one implementation, various components of the development optimization platform 102, one or more user devices 106, one or more databases 110, and/or other network components or computing devices described herein are communicatively connected to the network 104. Examples of the user devices 106 include a terminal, personal computer, a smart-phone, a tablet, a mobile computer, a workstation, and/or the like.

A server 108 may, in some instances, host the system. In one implementation, the server 108 also hosts a website or an application that users may visit to access the system 100, including the development optimization platform 102. The server 108 may be one single server, a plurality of servers with each such server being a physical server or a virtual machine, or a collection of both physical servers and virtual machines. In another implementation, a cloud hosts one or more components of the system. The development optimization platform 102, the user devices 106, the server 108, and other resources connected to the network 104 may access one or more additional servers for access to one or more websites, applications, web services interfaces, etc. that are used for well sequencing and unconventional reservoir management.

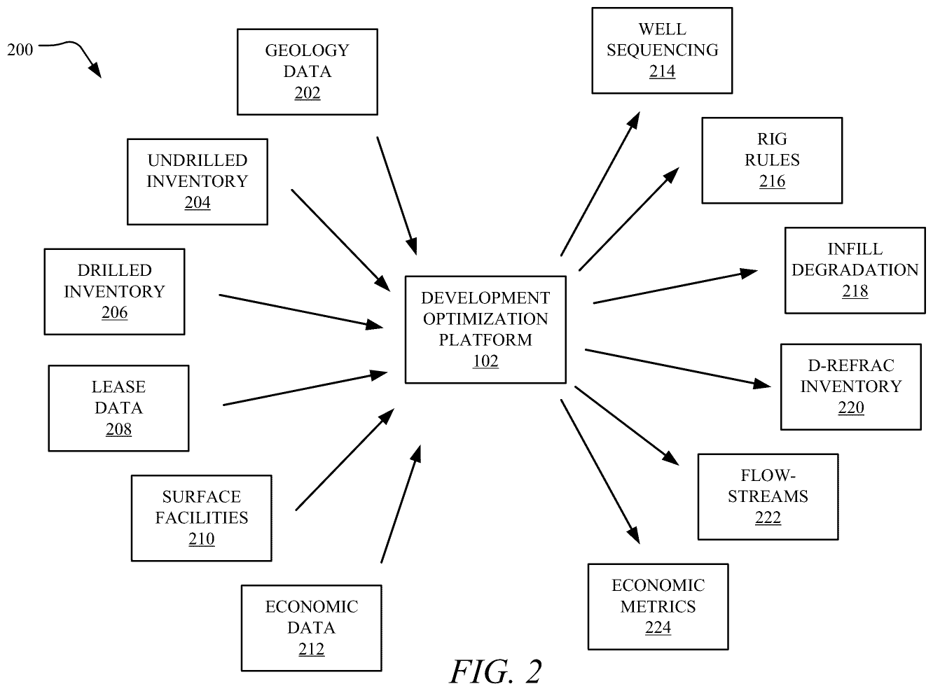

FIG. 2 is a block diagram illustrating example inputs and outputs of a development optimization platform 102, such as the platform illustrated in FIG. 1. In general, the development optimization platform 102 integrates several aspects of unconventional well development and planning from any number of databases, systems, platforms, etc. As shown in FIG. 2, the development optimization platform 102 may receive various types of data, such as geological data 202, undrilled well inventory data 204, drilled well inventory data 206, data on land leases or other leasing information 208, information or data associated with surface facilities of a site 210, and/or economic data 212. As mentioned, each of the various input data 202-212 to the development optimization platform 102 may be obtained or received from various databases or other sources of data/information. Such data may be transmitted to the development optimization platform 102 over network 104, such as from database 110. In some instances, the development optimization platform 102 may include one or more application programming interfaces (APIs) to communicate with the various sources of input data 202-212. In other instances, one or more devices may be located within the communication path between the sources of input data 202-212 and the development optimization platform 102 to obtain and provide the data.

The development optimization platform 102 may process and/or utilize the various input data 202-212 to determine well sequence or other reservoir management functions. For example, geological data 202 may be used to map variations in reservoir properties to underpin production forecasts and well design. Undrilled well inventory information 204 may be used to accurately plan well sequencing and development processes. For example, undrilled well inventory information 204 may include well location, well placement, spacing/stacking, lateral length, completion design, central facilities, pad, lease information, and/or other information for determining well sequencing. Similarly, dilled well inventory information 206 may include locations and production status of the drilled wells of a site. Such information may be utilized for evaluation of parent-child relationships, as well as for the automatic screening of defensive refracturing, or “refrac” candidates. The related input parameters may be well location, well placement, well design, completion size, central facilities, pad, lease information, historical and forecasted production rates of oil, gas, and water, etc.

In addition to the above, the development optimization platform 102 may receive lease data 208 from which continuous drilling clauses or low production risks may be obtained for the prioritization in well sequencing. Information on the capacity of well facilities and central facilities for production optimization across a site or field may be obtained from the surface facilities information 210. Economic data 212 may include, but is not limited to, long term price forecast, capital expenditure and operating expenses cost models, depreciation, tax, etc. Through the development optimization platform 102, a seamless process to centralize, manipulate, visualize, and analyze large volumes of data may be established to enable efficient development planning and effective reservoir management. To facilitate efficient interpretation and timely analysis of the data, the data may be automatically pulled from each of its core sources and merged into one single database, referred to herein as an Integrated Data Warehouse (IDW). The development optimization platform 102 may make the IDW available to other programs or systems such that data can be viewed or pulled by those systems or programs on-demand.

The development optimization platform 102 may process or otherwise utilize the input data 202-212 to generate various considerations, conclusions, predictions, analyses, and the like for well sequencing and reservoir management. For example, the development optimization platform 102 may provide long term project well sequencing 214, optimum rig count and rig distribution 216 in a target area, trend of infill degradation 218, defensive refract inventory and identification 220, periodic production rates or flowstreams 222 of oil, gas, natural gas liquids, water, etc., and/or economic metrics 224, such as net present value, internal rate of return, profitability index, cost, and the like. In general, many aspects of a drill site or field may be determined by the development optimization platform 102 through the information and data obtained from the multiple input sources 202-212.

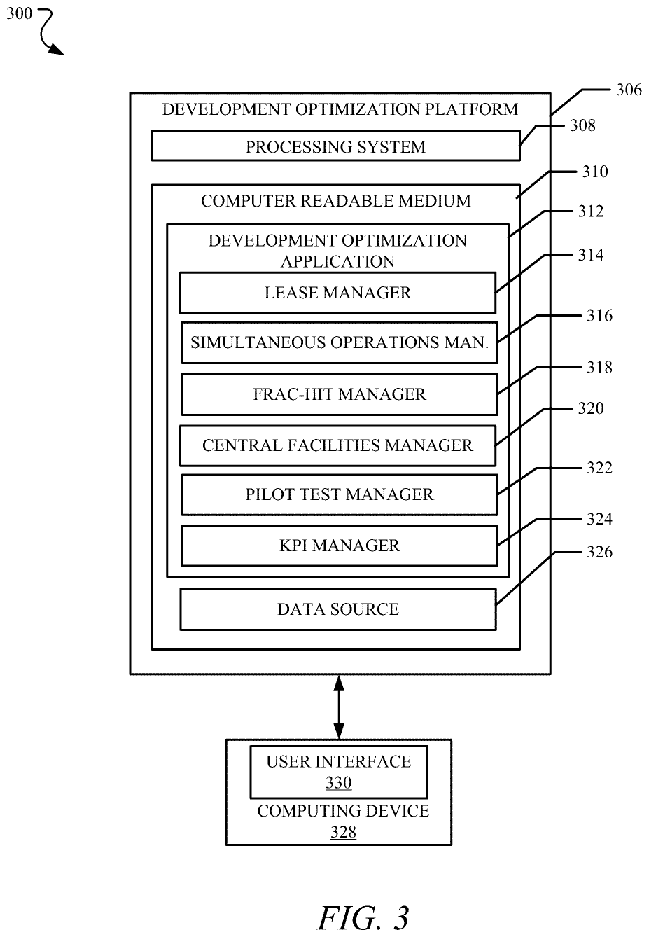

FIG. 3 shows an example block diagram of a development optimization system 300 for developing well sequencing and unconventional reservoir management. In general, the system 300 may include a development optimization platform 306. In one implementation, the development optimization platform 306 may be a part of the development optimization platform 102 of FIG. 1. As shown in FIG. 3, the development optimization platform 306 may be in communication with a computing device 328 providing a user interface 330. As explained in more detail below, the development optimization platform 306 may be accessible to various users to generate well sequencing and other management processes of unconventional reservoirs. In some instances, access to the development optimization platform 306 may occur through the user interface 330 executed on the computing device 328.

The development optimization platform 306 may include a development optimization application 312 executed to perform one or more of the operations described herein. The development optimization application 312 may be stored in a computer readable media 310 (e.g., memory) and executed on a processing system 308 of the development optimization platform 306 or other type of computing system, such as that described below. For example, the development optimization application 312 may include instructions that may be executed in an operating system environment, such as a Microsoft WindowsTM operating system, a Linux operating system, or a UNIX operating system environment. By way of example and not limitation, non-transitory computer readable medium 310 comprises computer storage media, such as non-transient storage memory, volatile media, nonvolatile media, removable media, and/or non-removable media implemented in a method or technology for storage of information, such as computer readable instructions, data structures, program modules, or other data.

The development optimization application 312 may also utilize a data source 326 of the computer readable media 310 for storage of data and information associated with the development optimization platform 306. For example, the development optimization application 312 may store received data or inputs, processing details, and/or output information, and the like. As described in more detail below, the generated well sequences and/or other reservoir management data may be stored and accessed via the user interface 330.

There are many variables and constraints in the well sequence optimization problem for unconventional development, due to its distinct features such as fast development pace, complicated lease requirements, and parent-child interaction. The larger the lease acreage, the more the complexities. The development optimization application 312 may include several components to address the challenges and incorporate such considerations in well sequencing. For example, the development optimization application 312 may include a lease manager 314 for managing and processing leases associated with a reservoir area or site. In general, leases with time-based obligations are usually of the highest priority as the benefit of the lease is limited by the term of the lease. Thus, a drilling schedule may be designed to meet the critical dates contained in a lease agreement. The leases associated with low production wells may also be actively monitored and the live data can be sourced from one or more databases to assist with prioritization and well sequencing and ensure leases associated with the site are maintained.

In another example, the development optimization application 312 may include a simultaneous operations manager 316 to monitor drilling and well activity that are in close proximity to each other. For example, as infill development progresses across a site, drilling and completion activities can occur in close proximity to each other and close to producing wells. Simultaneous operations in nearby wells may result in pressure communication between the wells. Management of the well sequencing may occur to reduce the negative impacts to production and to ensure subsurface containment. In some instances, the development optimization application 312 may utilize well spatial data to automatically identify the simultaneous operation events that may conflict with each other and avoid scheduling multiple simultaneous operation events within a certain time frame.

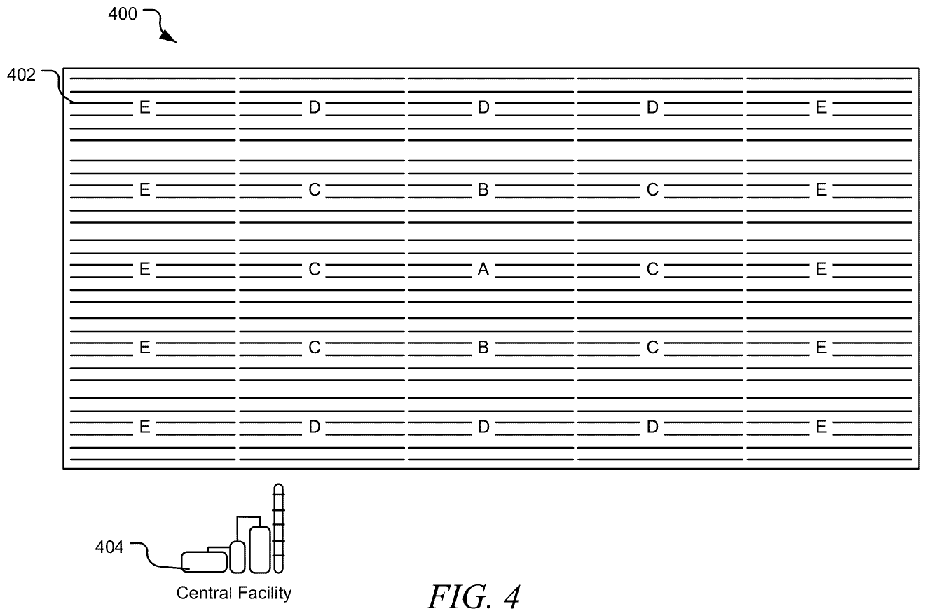

FIG. 4 illustrates an overhead representation of a field 400 with drilled and undrilled well events. In the illustration, each horizontal line 402 represents a horizontal well of the reservoir site or area 400, either drilled or undrilled. To illustrate the concept of the simultaneous well events, group A of the horizontal wells may be considered for inclusion in a well sequence for the field 400. In such a circumstance, wells in group B may be considered by the simultaneous operations manager 316 as potential simultaneous events as being in a side-by-side location with the group A wells. Wells in group C may be considered relatively close to through group A wells, but the overlap area with group A wells is small. Thus, depending on the orientation of the wells and the operation types, the simultaneous operations manager 316 may or may not identify the wells in group C as simultaneous events. On the other hand, wells in group D are further away from the group A wells and are, therefore, less likely to cause simultaneous operation risks. As such, the simultaneous operations manager 316 may identify wells in group D as simultaneous events depending on the actual distances, operation types, and fracture conductivity. In general, wells in group E do not have overlap with wells in group A such that the simultaneous operations manager 316 may regard those wells as non-simultaneous operations or events.

Returning to the system of FIG. 3, the development optimization application 312 may also include a frac-hit manager 318. A frac-hit is the inter-well communication between the parent well and the child well which is being stimulated. A frac-hit may cause pressure and/or water response in a parent well due to the activity in the child well and may even result in production impact of the parent and/or child well. Since the production impacts to parent wells are mostly negative, the frac-hit manager 318 may optimize infill drilling sequences to ensure a balance between preserving existing production and sustaining production growth. The frac-hit manager 318 may utilize well spatial data and forecasted production rates of parent wells to assess the risks and magnitude of the frac-hit impact to determine the best timing of infill drilling near producing wells.

The current and forecasted capacity of central facilities may be incorporated into the development optimization application 312 through the central facilities manager 320. In general, the central facilities manager 320 may monitor for risks of overloading the central facilities through the sequencing of wells of the field. In general, consideration of a central facilities may be an optional well sequencing constraint. If it is activated, the development optimization application 312 will consider the balance of the number of wells flowing to each central facility so that it will not be overloaded. This balancing may minimize the infrastructure requirements for building new central facilities or the need to expand existing ones. However, applying the central facilities constraint may not always be the best option as it may result in lower production in a certain period. Using the field 400 of FIG. 4 as an example, a central facility 404 may be located within, adjacent to, or otherwise near the field 400 for central control and monitoring of the wells of the field. The construction of and connection of wells to the central facility 404 may be costly, depending on the location of the central facility to the connected wells. In addition, each central facility 404 may be limited on the number of wells that can be monitored and controlled, requiring additional central facilities as more and more wells are added to the field. As such, the central facilities manager 320 may ensure a cost-efficient distribution of wells in the field based on the availability and capacity of the central facilities associated with the field.

The development optimization application 312 may also include a pilot test manager 322. A pilot test program may improve the knowledge and understanding of unconventional reservoirs, among other advantages. The learnings from pilot projects continue to inform the strategic decisions and increase the asset value of a field. Pilot wells may also be prioritized in the well sequencing to ensure the timely development decisions are made based on the results. In addition, the development optimization application 312 may include a key performance indicator (KPI) manager 324. The KPI manager 324 may screen and filter inventory wells according to the above considerations. The remaining wells may then be ranked and selected for the rig schedule based on the KPI. In some instances, the KPI may be determined automatically by the development optimization platform 306 or may be provided by a user, perhaps through the user interface 330 of the computing device 328. There may be multiple KPI options available. For example, the selected KPI may be production related, such as production volume or frac-hit production impact. The economics related to the KPI's, such as net present value, internal rate of return, profitability index, cost, and the like, can also be used. The flexibility of KPI selection allows the development optimization for different goals and objectives.

It should be appreciated that the components described herein are provided only as examples, and that the development optimization application 312 may have different components, additional components, or fewer components than those described herein. For example, one or more components as described in FIG. 3 may be combined into a single component. As another example, certain components described herein may be encoded on, and executed on other computing systems. Further, more or fewer of the components discussed above with relation to the development optimization platform 306 may be included with the tool, including additional components or modules included to perform the operations discussed herein.

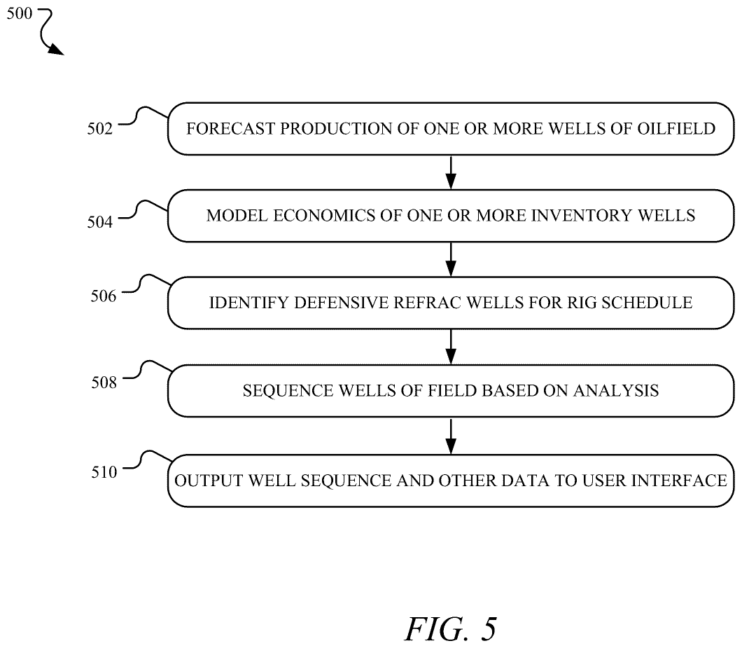

FIG. 5 illustrates example operations for utilizing a development optimization platform for well sequencing and unconventional well management. The operations may be performed by a computing device configured to execute any algorithm, including equation-oriented modeling techniques. Such operations may be executed through control of one or more hardware components, one or more software programs, or a combination of both hardware and software components of the computing device.

Beginning at operation 502, the computing device may forecast production of one or more wells of the field. In particular, periodically (such as every year on a schedule or any other periodic time frame), the development optimization system 102 may forecast a production level of one or more of the wells of the field. Forecast production may take different formats of production models for the single well production forecast. For example, a type-curve-based workflow may be used to forecast production of a well. The acreage of a field may be divided into several type curve areas with similar production performance and geological/reservoir characteristics. A type curve may be generated for each area to reflect an average performance profile (base case) without the infill degradation impact. For each inventory well, the development optimization system 102 may first calculate the infill degradation (if any) based on the parent properties, including number of parents, completion size, production condition, and distance. Then a monthly production profile may be generated by scaling the type curve by local geological/reservoir qualities, lateral length, and infill degradation.

At operation 504, the computing device associated with the development optimization system 102 may generate an economic model of one or more wells of the field. For example, the drilling, completion, and facility costs for the inventory wells may be estimated based on the locations and lateral lengths of inventory wells. The operational expenditures may be estimated based on the forecasted production rates and the other well properties. Other economic elements, such as depreciation, inflation, production tax, state and federal tax, may also be included in the economic models executed by the development optimization system 102. Further, the development optimization system 102 may identify defensive refrac wells at operation 506 to determine protection producing wells and to add incremental resources by repressurizing the area around the existing well and creating new fractures. For example, the development optimization system 102 may rank and select inventory wells for rig schedule, while simultaneously checking nearby parent wells to identify potential defensive refrac candidates based on their current production, offset distance, completion size, well design, and/or mechanical condition. The development optimization system 102 may assign the same development identifier to the defensive refracs and the associated infill wells to treat them as one entity to optimize scheduling and execution efficiency.

The development optimization system 102 may, at operation 508, may sequence wells of the field by automatically grouping inventory wells into multiple events based on their spatial information. The ranking and scheduling in this operation may be at an event level. Further, in some instances, the total number of wells that may be drilled in each schedule period may be determined from the user inputs. Initially, the development optimization system 102 may locate lease obligation wells at the top of the drilling order. If there are any pilot wells, such wells may be prioritized. Following, the development optimization system 102 may identify the events that pose simultaneous event risks or frac-hit risks to the drilled/scheduled events and exclude such wells from the current schedule year. If the central facility capacities option is activated, the extra wells that would overload the central facilities may then be also filtered out. With all constraints considered and selected wells excluded, development optimization system 102 ranks the remaining events based on their average KPI and populates the remaining inventory accordingly.

The operations of the method 500 discussed above may be repeated for each period of set time, such as each scheduled year, to capture the changing reservoir and well conditions. For example, the pressure and production rates of existing wells may decrease with time, which may change the evaluation results for frac-hit and infill degradation, among other changes. Also, scheduled inventory wells can become parents for the future infills in the following schedule years and central facilities at full capacity can become significantly under-utilized in just a few years. Due to the changes of the input variables over time, a dynamic workflow may be utilized to account for these variances in order to deliver the most reliable results for well sequencing and development optimization. However, the whole process can be computationally intensive for medium and large asset due to long field life, large number of wells, and many other considerations. Efficient automated calculation is enabled in the development optimization platform 102. As a result, the well sequence for several thousand of wells over multiple development years or other time periods can be created in minutes.

At step 510, the development optimization system 102 may output well sequences or other data to a user interface, such as user interface 330 executed by computing device 328, for display to a user of the computing device. In other instances, the development optimization system 102 may provide the output data and results to a computing device for further processing. For example, a computing device may initiate one or more processes based on the provided well sequence or other output data. Such processes may include requisitioning the drilling of a new well, automatic ordering of components, generating one or more output reports for the field, configuring one or more systems based on the output data, and the like. In general, any process or system associated with the field may be configured, altered, updated, or initiated based on the output data provided by the development optimization system 102.

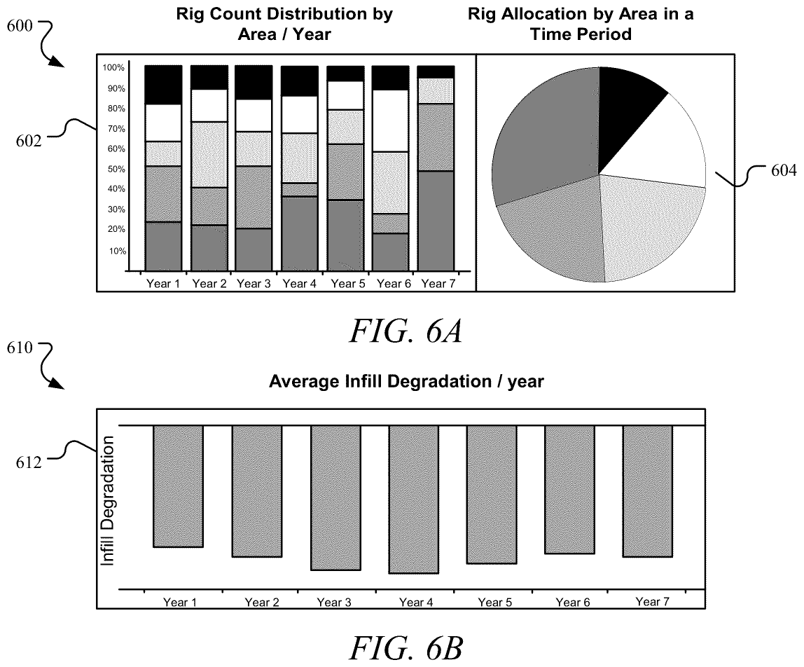

As mentioned, the development optimization system 102 may output well sequences and other data to the user interface 330 for display. Multiple dashboards may be generated based on the data provided by the development optimization system 102 for selecting user inputs, data quality control and visualization, performance analysis, sensitivity scenarios, and the like. For example, FIG. 6A is an example user interface illustrating a bar chart and pie chart of rig allocation over time in different type curve areas of a field based on data from a development optimization platform 102. In particular, a first portion of the user interface 600 includes a bar chart 602 illustrating rig allocation over time in different type curve areas. A second portion 604 of the user interface 600 includes a pie chart illustrating a percentage of the total rig count in different type curve areas. FIG. 6B is an example user interface 610 illustrating a bar chart of change of average infill degradation over time of a field based on data from a development optimization platform 102. The data results from the development optimization system 102 are illustrated for a random 7-year period, although any time period may be selected for display. Performance and results of the field may be obtained from the displayed results, such as a spatial trend of field development by mapping the important well metrics over the field acreage. The inventory wells with poor production performance or economics can then be easily identified for optimization.

Scenario analysis provided by the development optimization platform 102 may also be useful for development optimization. For example, when multiple development options are available, the development optimization platform 102 can take different inputs and generate the results of multiple scenarios for comparison and optimization.

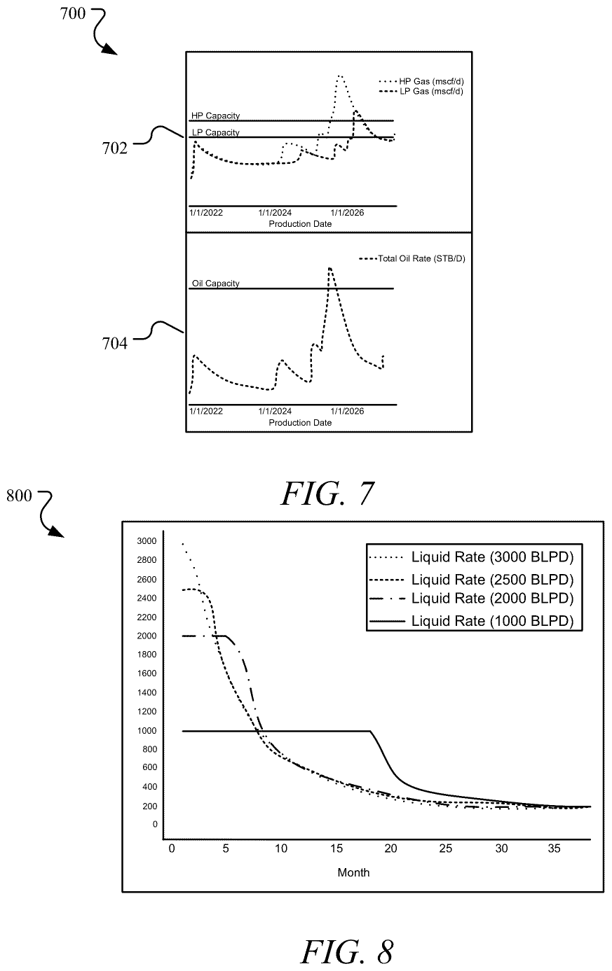

The user interface 330 may also include a central facilities section or dashboard. The central facility dashboard in development optimization platform 102 may be utilized to check the total rate profile of any selected central facility. Both existing production wells and future wells may be included. In case of any potential rate constraints, early action can be taken to either optimize the development well sequence or start evaluating the economics of building new central facilities or expanding the existing ones. FIG. 7 an example user interface 700 illustrating line graphs 702-704 of change of the effect of a central facility constraint on aspects of output data of a field. Line graph 702 illustrates a gas capacity target in relation to has production of the field. Line graph 704 illustrates an oil capacity target in relation to has production of the field. As can be seen, the selected central facility is under capacity until mid-2025, after which the total gas rate flowing to it will exceed capacity for more than a year. Through the use of the development optimization platform 102, the capacity issue can be flagged early for further optimization.

The development optimization platform 102 can also be utilized to reshape the production rate profiles of inventory wells based on well facility capacities. FIG. 8 is an example user interface illustrating line graphs of different well outputs based on different well facilities capabilities. Different scenarios are generated by reshaping the well production profiles with different well facility designs and the well facility costs are also varied accordingly. The results of all scenarios are then compared through the user interface 800 to select the optimum design based on the preferred KPI.

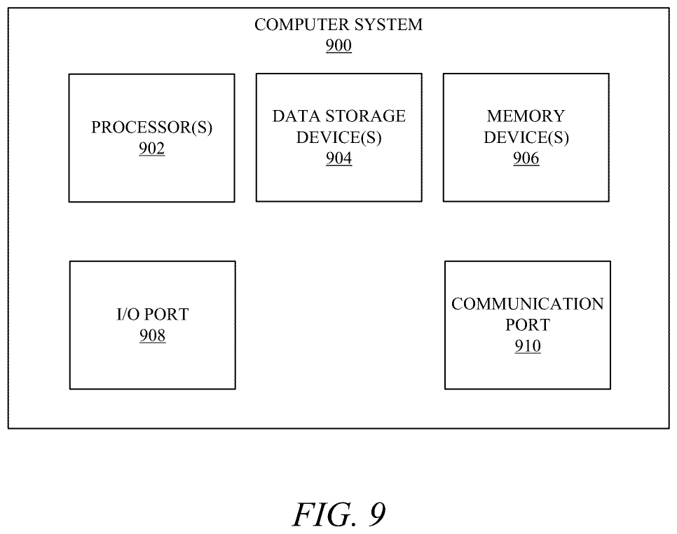

Referring to FIG. 9, a detailed description of an example computing system 900 having one or more computing units that may implement various systems and methods discussed herein is provided. The computing system 900 may be applicable to the development optimization platform 102 of FIG. 1, the system 100, and other computing or network devices. It will be appreciated that specific implementations of these devices may be of differing possible specific computing architectures not all of which are specifically discussed herein but will be understood by those of ordinary skill in the art.

The computer system 900 may be a computing system is capable of executing a computer program product to execute a computer process. Data and program files may be input to the computer system 900, which reads the files and executes the programs therein. Some of the elements of the computer system 900 are shown in FIG. 9, including one or more hardware processors 902, one or more data storage devices 904, one or more memory devices 906, and/or one or more ports 908-910. Additionally, other elements that will be recognized by those skilled in the art may be included in the computing system 900 but are not explicitly depicted in FIG. 9 or discussed further herein. Various elements of the computer system 900 may communicate with one another by way of one or more communication buses, point-to-point communication paths, or other communication means not explicitly depicted in FIG. 9.

The processor 902 may include, for example, a central processing unit (CPU), a microprocessor, a microcontroller, a digital signal processor (DSP), and/or one or more internal levels of cache. There may be one or more processors 902, such that the processor 902 comprises a single central-processing unit, or a plurality of processing units capable of executing instructions and performing operations in parallel with each other, commonly referred to as a parallel processing environment.

The computer system 900 may be a conventional computer, a distributed computer, or any other type of computer, such as one or more external computers made available via a cloud computing architecture. The presently described technology is optionally implemented in software stored on the data stored device(s) 904, stored on the memory device(s) 906, and/or communicated via one or more of the ports 908-910, thereby transforming the computer system 900 in FIG. 9 to a special purpose machine for implementing the operations described herein. Examples of the computer system 900 include personal computers, terminals, workstations, mobile phones, tablets, laptops, personal computers, multimedia consoles, gaming consoles, set top boxes, and the like.

The one or more data storage devices 904 may include any non-volatile data storage device capable of storing data generated or employed within the computing system 900, such as computer executable instructions for performing a computer process, which may include instructions of both application programs and an operating system (OS) that manages the various components of the computing system 900. The data storage devices 904 may include, without limitation, magnetic disk drives, optical disk drives, solid state drives (SSDs), flash drives, and the like. The data storage devices 904 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 906 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 904 and/or the memory devices 906, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 900 includes one or more ports, such as an input/output (I/O) port 908 and a communication port 910, for communicating with other computing, network, or reservoir development devices. It will be appreciated that the ports 908-910 may be combined or separate and that more or fewer ports may be included in the computer system 900.

The I/O port 908 may be connected to an I/O device, or other device, by which information is input to or output from the computing system 900. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 900 via the I/O port 908. Similarly, the output devices may convert electrical signals received from computing system 900 via the I/O port 908 into signals that may be sensed as output by a human, such as sound, light, and/or touch. The input device may be an alphanumeric input device, including alphanumeric and other keys for communicating information and/or command selections to the processor 902 via the I/O port 908. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 900 via the I/O port 908. For example, an electrical signal generated within the computing system 900 may be converted to another type of signal, and/or vice-versa. In one implementation, the environment transducer devices sense characteristics or aspects of an environment local to or remote from the computing device 900, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 900, such as, physical movement of some object (e.g., a mechanical actuator), heating or cooling of a substance, adding a chemical substance, and/or the like.

In one implementation, a communication port 910 is connected to a network by way of which the computer system 900 may receive network data useful in executing the methods and systems set out herein as well as transmitting information and network configuration changes determined thereby. Stated differently, the communication port 910 connects the computer system 900 to one or more communication interface devices configured to transmit and/or receive information between the computing system 900 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 910 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 910 may communicate with an antenna or other link for electromagnetic signal transmission and/or reception.

In an example implementation, waterflood model data, and software and other modules and services may be embodied by instructions stored on the data storage devices 904 and/or the memory devices 906 and executed by the processor 902. The computer system 900 may be integrated with or otherwise form part of the development optimization platform 102.

The system set forth in FIG. 9 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for optimizing production of a field, the method comprising:
receiving, using a processing device and from a plurality of databases, field data corresponding to one or more wells of the field;
generating, based on the received field data, a production forecast for the one or more wells of the field;
verifying potential defensive refract candidates of the one or more wells of the field; and
generating, based on production forecast and verified potential defensive refract candidates, a well development sequence for the field.

2. The method of claim 1, wherein the production forecast is generated through a type-curve workflow of the field data.

3. The method of claim 1 further comprising:
modeling, based on the production forecast for the one or more wells of the field, an economic performance of the field, the economic performance at least partially based on a location and lateral length of the one or more wells.

4. The method of claim 1, wherein verifying the potential defensive refract candidates is based on one of a current production, an offset distance, a completion size, a well design, or a mechanical condition of the well within a particular distance to a target well of the field.

5. The method of claim 4, wherein verifying the potential defensive refract candidates indicates a simultaneous operations event, and generating the well development sequence comprising removing the potential defensive refract candidate from the sequence.

6. The method of claim 1, wherein the field data comprises at least one of geology data, drilled or undrilled inventory data, lease data, or economic data.

7. The method of claim 1, wherein generating the well development sequence for the field is further based on data associated with one or more pilot wells.

8. The method of claim 1, wherein generating the well development sequence for the field is further based on ranking of one or more key performance indicators of the one or more wells of the field.

9. The method of claim 1 further comprising:
displaying, in a user interface, the generated well development sequence for the field.

10. One or more tangible non-transitory computer-readable storage media storing computer-executable instructions for performing a computer process on a computing system, the computer process comprising:
receiving, using a processing device and from a plurality of databases, field data corresponding to one or more wells of the field;
generating, based on the received field data, a production forecast for the one or more wells of the field;
verifying potential defensive refract candidates of the one or more wells of the field; and
generating, based on production forecast and verified potential defensive refract candidates, a well development sequence for the field.

11. The one or more tangible non-transitory computer-readable storage media of claim 10, wherein the production forecast is generated through a type-curve workflow of the field data.

12. The one or more tangible non-transitory computer-readable storage media of claim 10, wherein the computer process further comprises:
modeling, based on the production forecast for the one or more wells of the field, an economic performance of the field, the economic performance at least partially based on a location and lateral length of the one or more wells.

13. The one or more tangible non-transitory computer-readable storage media of claim 10, wherein verifying the potential defensive refract candidates is based on one of a current production, an offset distance, a completion size, a well design, or a mechanical condition of the well within a particular distance to a target well of the field.

14. The one or more tangible non-transitory computer-readable storage media of claim 13, wherein verifying the potential defensive refract candidates indicates a simultaneous operations event, and generating the well development sequence comprising removing the potential defensive refract candidate from the sequence.

15. The one or more tangible non-transitory computer-readable storage media of claim 10, wherein the field data comprises at least one of geology data, drilled or undrilled inventory data, lease data, or economic data.

16. The one or more tangible non-transitory computer-readable storage media of claim 10, wherein generating the well development sequence for the field is further based on data associated with one or more pilot wells.

17. A system optimizing production of a field, the system comprising:
a processor;
a communication port receiving, from a plurality of databases, field data corresponding to one or more wells of the field; and
a non-transitory computer-readable medium encoded with instructions, which when executed by the processor, cause the processor to:
generate, based on the received field data, a production forecast for the one or more wells of the field;
verify potential defensive refract candidates of the one or more wells of the field;
model, based on the production forecast for the one or more wells of the field, an economic performance of the field, the economic performance at least partially based on a location and lateral length of the one or more wells; and
generate, based on modeled economic performance and verified potential defensive refract candidates, a well development sequence for the field.

18. The system of claim 17, wherein verifying the potential defensive refract candidates is based on one of a current production, an offset distance, a completion size, a well design, or a mechanical condition of the well within a particular distance to a target well of the field.

19. The system of claim 18, wherein verifying the potential defensive refract candidates indicates a simultaneous operations event, and generating the well development sequence comprising removing the potential defensive refract candidate from the sequence.

20. The system of claim 17 further comprising:
a display device in communication with the processor, the instructions causing the processor to display, on the display device, the generated well development sequence for the field.
